(19) United States
(12) Patent Application Publication
(10) Pub. No.: US 2008/0134916 A1
(43) Pub. Date: Jun. 12, 2008

(54) Printing Press with a Washing Device for an Inking Unit and Method of Removing Ink from an Inking Unit

(75) Inventors: Ulrich Luckhardt, Heidelberg (DE); Thomas Rosemann, Bissendorf (DE)

Correspondence Address: LERNER GREENBERG STEMER LLP, P O BOX 2480, HOLLYWOOD, FL, 33022-2480, US

(73) Assignee: HEIDELBERGER DRUCKMASCHINEN AG, Heidelberg (DE)

(21) Appl. No.: 11/952,292

(22) Filed: Dec. 7, 2007

(30) Foreign Application Priority Data
Dec. 7, 2006 (DE) DE102006057684.5

(51) Int. Cl. B41F 35/04

(52) U.S. Cl. 101/425; 101/483

(57) ABSTRACT

A printing press includes inking units having rollers provided with a phobic coating made of a material of low surface energy. At least one roller of the inking unit remains uncoated. Ink residues are stripped off the uncoated roller and removed by a blade during a cleaning operation. A method of removing ink from an inking unit of a printing press is also provided.

### CROSS-REFERENCE TO RELATED APPLICATION

This application claims the priority, under 35 U.S.C. §119, of German Patent Application DE 10 2006 057 684.5, filed Dec. 7, 2006; the prior application is herewith incorporated by reference in its entirety.

### BACKGROUND OF THE INVENTION

### Field of the Invention

The invention relates to a printing press including at least one printing unit and at least one inking unit for inking a printing plate. The inking unit has inking rollers and a cleaning device associated with the inking rollers. The cleaning device has a blade device for removing ink from the inking unit. The invention also relates to a method of removing ink from an inking unit.

In printing presses that include roller-type inking units for supplying ink to the printing form or printing plate, it has been known for a long time to strip ink off one of the rollers of the inking unit through the use of a blade, for example to clean the roller when ink of a different color is to be used or to limit the ink to the format of the paper to be printed. Inking units and cleaning devices which are suited for that purpose are described, for example, in German Published, Non-Prosecuted Patent Application DE 195 11 231 B4, corresponding to UK Patent Application GB 2 299 300 A; German Published, Non-Prosecuted Patent Application DE 197 08 435 C2, corresponding to U.S. Pat. No. 6,116,161; and German Published, Non-Prosecuted Patent Application DE 10 2005 015 790 A1. In general, the rollers in the known inking units are formed of a material that has good ink-accepting properties such as rubber or Rilsan® high performance polyamides, both of which are materials that have a relatively high surface energy. On one hand, it is true that the rollers of those inking units accept ink very well, but on the other hand, it is hard to remove the ink from the inking unit, in particular when the printing unit in question is a conventional inking unit with a vibrator roller, ink key zones, and with a multiplicity of up to 20 rollers all carrying ink. When such an inking unit is to be changed over from supplying ink of a relatively dark color to supplying ink of a light color such as yellow, relatively long washing times are required. Attempts have been made to reduce the required washing time by using special solvents or detergents. Another attempt is to introduce the detergent at different locations in the inking unit at the same time to accelerate the cleaning process. However, both measures have their limitations because, on one hand, detergents based on biodegradable substances are preferred for ecological reasons and, on the other hand, the introduction of detergents at different locations in the inking unit requires complex structural measures and auxiliary equipment that may be impossible to integrate due to space restrictions.

It is known from German Published, Non-Prosecuted Patent Application DE 101 03 585 A1 to coat the screen roller of a short inking unit with a hydrophobic organosilicon compound to prevent dampening solution from collecting in the pores of the roller. The problem of washing the inking unit is not dealt with in that document.

German Published, Non-Prosecuted Patent Application DE 199 48 311 A1, and German Published, Non-Prosecuted Patent Application DE 10 2004 054 425 A1, corresponding to U.S. Patent Application Publication No. US 2006/0185541 A1, for example, propose to coat the rollers in the inking units of printing presses with a fluoroelastomeric coating. Fluoroelastomers have a relatively low surface energy. Inking units that are equipped with rollers of that kind are easier to clean because the ink does not adhere to the rollers as strongly as to rollers made of Rilsan or hard rubber, for example. However, the process of cleaning inking units equipped with rollers of that kind is not necessarily faster because even in those inking units it takes time to transport the ink from remote locations to the cleaning device over the ink-splitting behavior of the rollers and then to strip off the ink.

A changeover from ink of a dark color to ink of a light color is especially problematic. After the cleaning operation, the inking unit generally needs to be cleaned again with a paste that is applied to the rollers and distributed in the inking unit by rotation. Then the paste is washed off the rollers through the use of the inking unit washing device and the light-color ink is introduced. However, in order to remove remaining pigments of the dark-color ink from the roller surfaces, the light-color ink is usually washed off again before the actual ink feeding operation is started for a subsequent “clean” printing operation.

### BRIEF SUMMARY OF THE INVENTION

It is accordingly an object of the invention to provide a printing press with a washing device for an inking unit and a method of removing ink from an inking unit, which overcome the hereinafore-mentioned disadvantages of the heretofore-known devices and methods of this general type, which reduce downtime of a printing press due to washing operations and in which cleaning a roller-type inking unit is faster than with known methods.

With the foregoing and other objects in view there is provided, in accordance with the invention, a printing press, comprising at least one printing unit having a printing plate, and at least one inking unit for inking the printing plate. The inking unit has inking rollers and a cleaning device associated with the inking rollers. The cleaning device has a blade device for removing ink from the inking unit. The inking rollers include first rollers having a surface made of at least one material with a relatively lower surface energy and, at least during a cleaning operation, at least one second roller having a surface made of at least one material with a relatively higher surface energy than the at least one material of the surface of the first rollers. The blade device interacts with the at least one second roller.

With the objects of the invention in view, there is also provided a method of removing ink from an inking unit of a printing press. The method comprises providing a plurality of first ink-guiding rollers or cylinders having a surface formed of materials with a relatively lower surface energy and a plurality of second-type rollers having a surface formed of a material with a relatively higher surface energy. At least one of the second-type rollers is assigned to the inking unit, at least during an operation to remove ink from the inking unit. The ink is stripped off at least one of the second-type rollers.

The invention is based on the realization that when one or more rollers made of a material that has a relatively high surface energy are provided in the ink path of an inking unit that is equipped with rollers coated with materials of a relatively low surface energy, the ink will collect on the roller or rollers that have a relatively high surface energy and can be stripped off these rollers more effectively. Mixing rollers of different types as described above achieves two things: On one hand, during an ink change, the ink that has been partly dissolved can be easily removed from the rollers of the first type because these rollers have a low surface energy due to the fluoroelastomeric coating, for example. On the other hand, the roller of the second type, made of a material with a high surface energy such as Rilsan, hard rubber, or copper, or of conventional soft rubber materials, acts as an “ink collector” in that it strongly attracts the dissolved ink, which can then be removed, i.e. stripped off, effectively from the roller or rollers of the second type.

Not only does this measure reduce the washing time, it also reduces detergent consumption. Moreover, an ink change requires less effort because there is no longer a need for pastes in the cleaning process, and in the case of a changeover from dark-color ink to light-color ink it is no longer necessary to introduce then wash off the light-color ink before the actual ink feed to ensure that the ink that will be used in the printing operation will be clean. The “phobic” coating of the rollers of the inking unit prevents ink pigments from penetrating into the pores of the roller surface.

Thus, the invention combines the advantages of an inking unit equipped with what are known as “phobic” rollers, i.e. rollers coated with a material of low surface energy, for example a fast ink removal from the rollers, a longer useful life of rubber rollers with a phobic coating, and the fact that the ink pigments do not adhere to the rubber material to the same extent as in conventional rollers, with an accelerated washing operation due to the use of one or more rollers of high surface energy at the location of the cleaning device, i.e. the washing blade.

It may be useful to provide further rollers with high surface energy in the vicinity of the roller with high surface energy that is in engagement with the washing blade in order to assist in the collection of ink from the inking unit otherwise equipped with rollers of relatively low surface energy.

In addition, it is useful for the roller that is in engagement with the washing blade to have a hard surface because rollers with a hard surface have better resistance to wear than rollers with a soft rubber jacket.

The roller or rollers of the second type, i.e. the rollers that have a relatively high surface energy may, for example, be a distributor roller, which is part of the inking unit during the printing operation, too. Alternatively, it is possible to assign the second-type roller of high surface energy to the cleaning device and to bring the second-type roller and the washing blade into engagement with the rollers of the inking unit, which are coated with materials of low surface energy, only during the cleaning or washing operation.

Other features which are considered as characteristic for the invention are set forth in the appended claims.

Although the invention is illustrated and described herein as embodied in a printing press with a washing device for an inking unit and a method of removing ink from an inking unit, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, longitudinal-sectional view of a four-color sheet-fed offset printing press equipped with a conventional inking unit, i.e. an inking unit including a vibrator roller and ink zone keys, that has been modified in accordance with the invention;

FIG. 2 is a sectional view of a roller diagram of an inking unit 8a in a printing unit 7a in accordance with a first exemplary embodiment of the invention;

FIGS. 3 to 7 are sectional views of roller diagrams of alternative exemplary embodiments of the inking unit shown in FIG. 2; and

FIG. 8 is a sectional view of a roller diagram of an exemplary embodiment of the invention for an anilox printing unit.

### DETAILED DESCRIPTION OF THE INVENTION

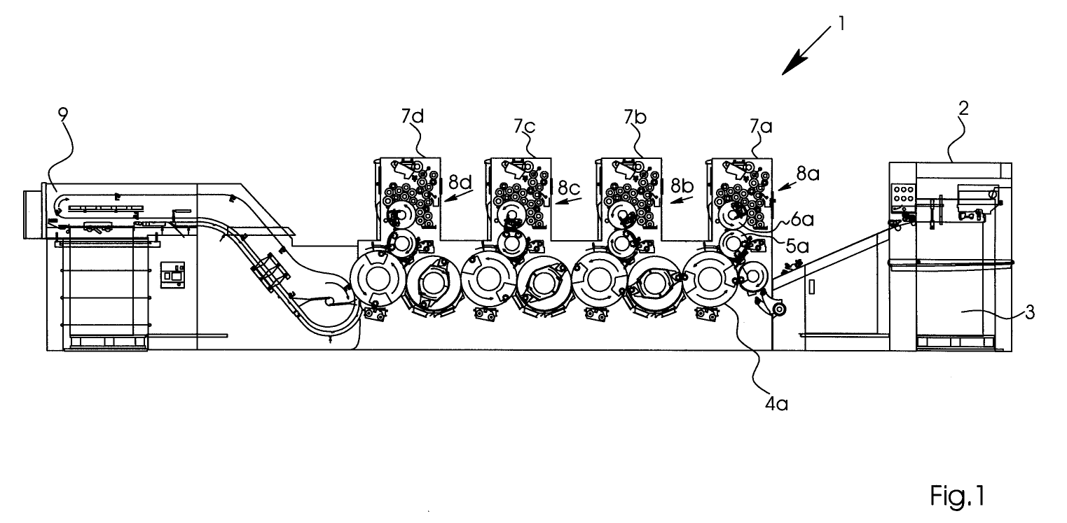

Referring now to the figures of the drawings in detail and first, particularly, to FIG. 1 thereof, there is seen an offset printing press 1 of in-line construction with a feeder 2 containing a stack 3 of unprinted sheets of paper, and four printing units 7a-d for the four process colors black, yellow, magenta, and cyan. The fourth printing unit 7d is followed by a delivery 9 of the printing press. Gripper bars in the delivery 9 revolve through the use of a chain guide. The gripper bars take over the printed sheet and feed it to a sheet stack on which it is deposited.

It is seen that the first printing unit 7a includes an impression cylinder 4a, a blanket cylinder 5a and a form cylinder or plate cylinder 6a, which carries the respective printing plate, although each of the four printing units 7a-d includes those cylinders as shown. Inking units 8a-d, which will be described in greater detail below, supply ink to the printing plates.

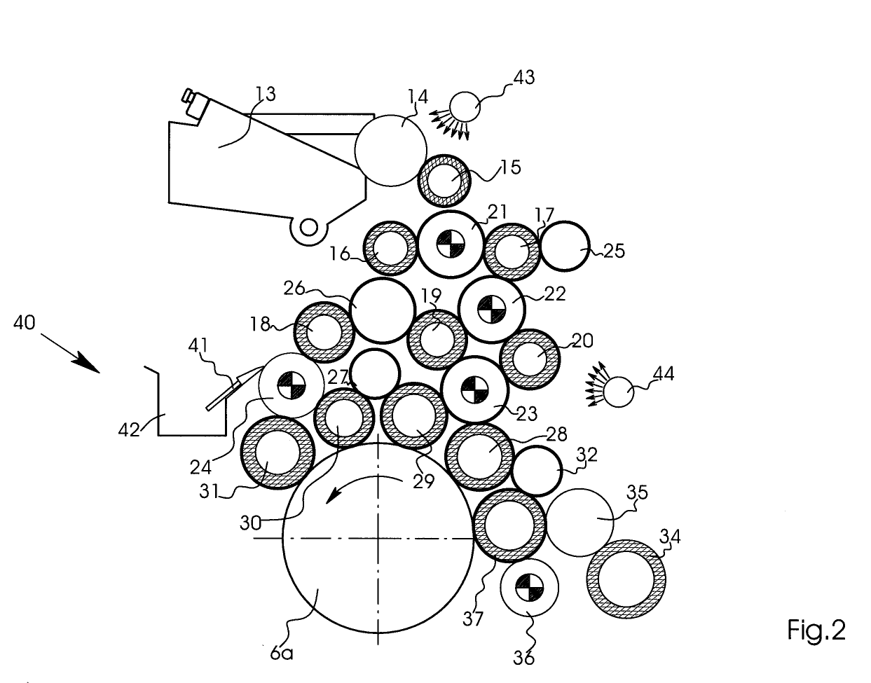

The inking unit shown in FIG. 2 is formed of a blade-type ink fountain 13, a fountain roller 14, four inking form rollers or ink applicator rollers 28, 29, 30 and 31, which apply ink to the printing plate on the cylinder 6a, and a number of further rollers 15 to 27, which receive ink from the fountain roller 14, distribute the ink, and feed the ink to the applicator rollers. Reference numeral 15 designates a vibrator roller, which cyclically oscillates between the fountain roller 14 and the roller 21. The rollers 21, 22, 23 and 24 are distributor rollers that reciprocate in the axial direction, with the rollers 23 and 24 being cooled. The ink fountain roller 15 and the rollers 16, 17, 18, 19, 20 as well as the four ink applicator rollers 28 to 31 are equipped with a rubber jacket. A bridge roller 32, which is disposed between a dampening form roller or dampening solution applicator roller 37 and the first ink applicator roller 28, as well as the rollers 27, 26 and 25, are steel rollers.

With the exception of rollers 34, 35 and 36 of the dampening unit, the fountain roller 14 and the roller 24, which will be described in greater detail below, all of the other rollers 15 to 31, 32 and 37 of the inking unit are coated with what is referred to as a “phobic” coating being 0.1 mm in thickness and made of a fluoroelastomeric material, as is indicated by thicker lines at the circumference of the rollers. The material may be TFE-HFP-VDF (tetrafluoroethylene-hexafluorpropylene-vinylidenfluoridecopolymer), for example.

As compared to the surface energy of conventional Rilsan, hard rubber, or copper rollers, this material has a relatively low surface energy. The coating protects the relatively soft rubber jackets of the rollers 15 to 20, 28 to 31 and 37 against wear and prevents ink pigments from penetrating into the rubber layer. The coating also ensures that it is comparatively easy to remove the ink from the surface of the rollers during a washing operation.

A cleaning device 40 with a trough 42 and a washing blade 41 is provided for the purpose of cleaning the inking unit. The washing blade 41 can be brought into engagement with the roller 24. Moreover, spray tubes are provided for spraying washing liquids into the inking unit at locations indicated by reference numerals 43 and 44.

In contrast to the other rollers of the inking unit, the distributor roller 24 does not have a “phobic” coating. Instead, it has a Rilsan coating, which is a common type of coating for distributor rollers. During the washing operation, the ink dissolved by the washing liquid preferably collects on this Rilsan surface, because Rilsan has a comparatively high surface energy compared to a “phobic” TFE-HFP-VDF coating. Consequently, it is possible to remove the ink effectively from the inking unit at this location through the use of the washing blade 41.

The roller 24 may, of course, also be a roller formed of hard rubber, copper, or any other material, or a roller coated with such materials of comparatively high surface energy.

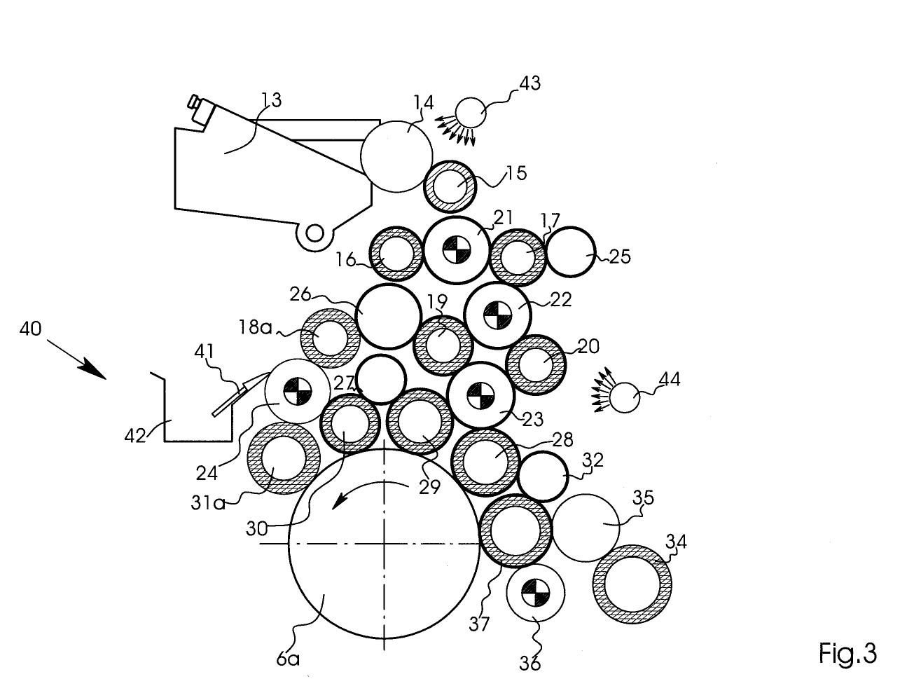

The exemplary embodiment shown in FIG. 3 differs from that shown in FIG. 2 in that the rollers 18a and 31a adjacent the roller 24 do not have a “phobic” coating. Instead, as is likewise indicated by the thicker lines at the outer periphery, they are provided with a Rilsan coating or have only the bare rubber jacket. Thus, these two rollers likewise attract the dissolved ink, namely the ink from the “rear” branch of the ink path and from the printing plate on the plate cylinder 6a.

In accordance with a further exemplary embodiment, the third applicator roller 30, as viewed in the direction of rotation of the plate cylinder 6a, is merely provided with a rubber jacket but not with the phobic fluoroelastomeric coating. In this exemplary embodiment, the surfaces of all of the rollers adjacent the distributor roller 24 are equipped with ink-receptive or oleophillic materials of relatively high surface energy. Thus, optimum results in view of the “collection” of dissolved ink during the washing operation are ensured due to a multiple contact of these rollers with the “phobic” rollers in the inking unit and at the plate cylinder.

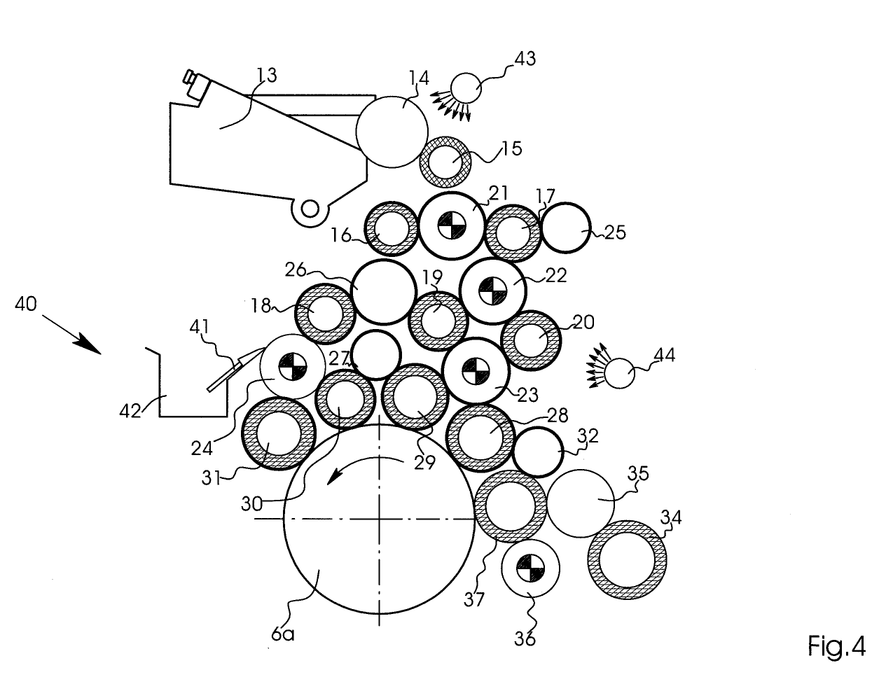

In the exemplary embodiment shown in FIG. 4, the inking unit substantially corresponds to the one shown in FIG. 2, with the exception of the vibrator roller 15, which now only has a conventional rubber jacket rather than a phobic coating. The reason for this is the reciprocating movement of the vibrator roller 15, which cyclically contacts the fountain roller 14 and the distributor roller 21. This movement would cause a phobic coating to wear easily, so that it makes sense not to use such a coating for the vibrator roller in the first place. Another difference between the embodiment shown in FIG. 4 and the embodiments described above is that in FIG. 4, the dampening form roller or dampening solution applicator roller 37 only has a conventional rubber jacket to improve the water-conducting properties of the surface of this roller or rather to avoid influencing the water-conducting properties by a phobic coating.

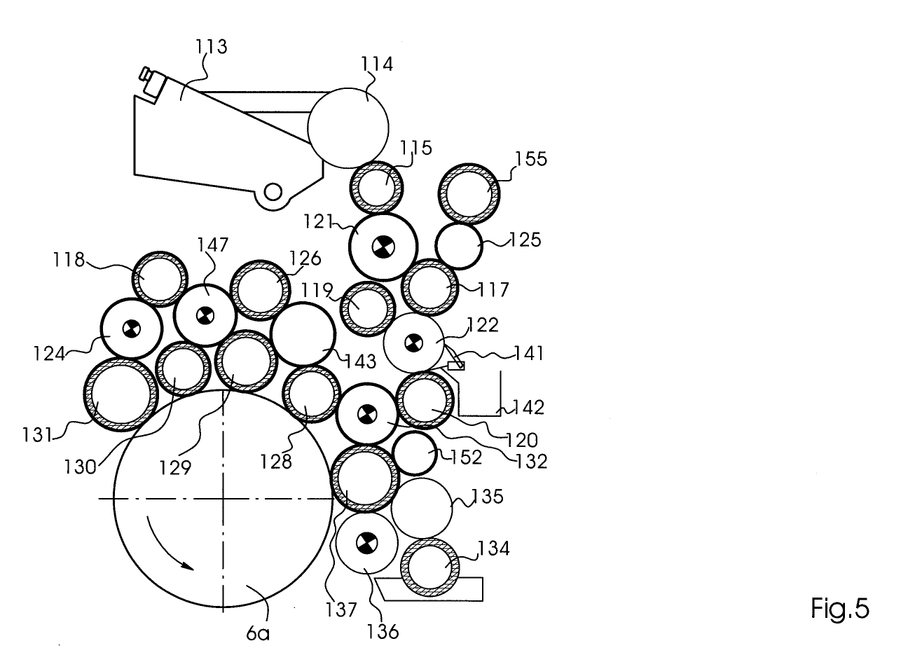

The structure of the inking unit shown in FIG. 5 differs from the exemplary embodiments described above. This inking unit has a distributor roller 122 at a central location in the ink path. In contrast to the other rollers of the inking unit, which have a phobic coating as indicated by the thick lines, this distributor roller 122 does not have a phobic coating. Instead, the distributor roller 122 has a Rilsan, hard rubber, or copper surface. During a washing operation, a washing blade 141 with a collecting trough 142 contacts this distributor roller 122. The reference numerals of rollers that have a similar function to those in the inking units illustrated in FIGS. 2 to 4 have been increased by 100 and are not mentioned again at this point.

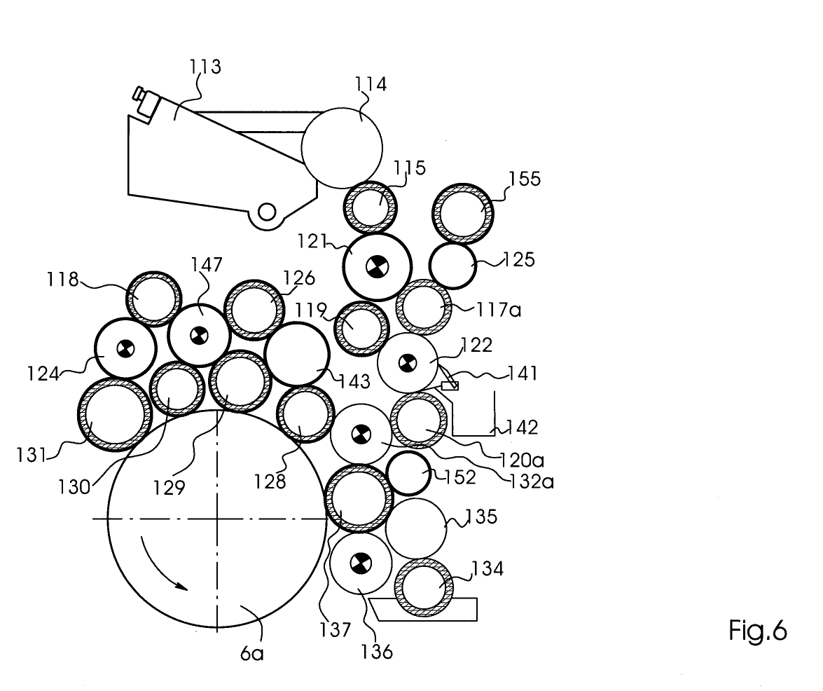

The exemplary embodiment shown in FIG. 6 differs from the one shown in FIG. 5 in that, in addition to the distributor roller 122, rollers 117a and 120a adjacent the distributor roller 122 and a distributor roller 132a engaging the roller 120a are uncoated and have a conventional jacket made of a material of comparatively high surface energy. These four non-phobic rollers are at a central location in the ink path and are therefore particularly suited for collecting the dissolved ink residues, which can subsequently be stripped off at the distributor roller 120 through the use of a blade. Of course, in this inking unit it is likewise possible to leave the dampening solution applicator roller 137 or the vibrator roller 115 uncoated, as is the case in the exemplary embodiment shown in FIG. 4.

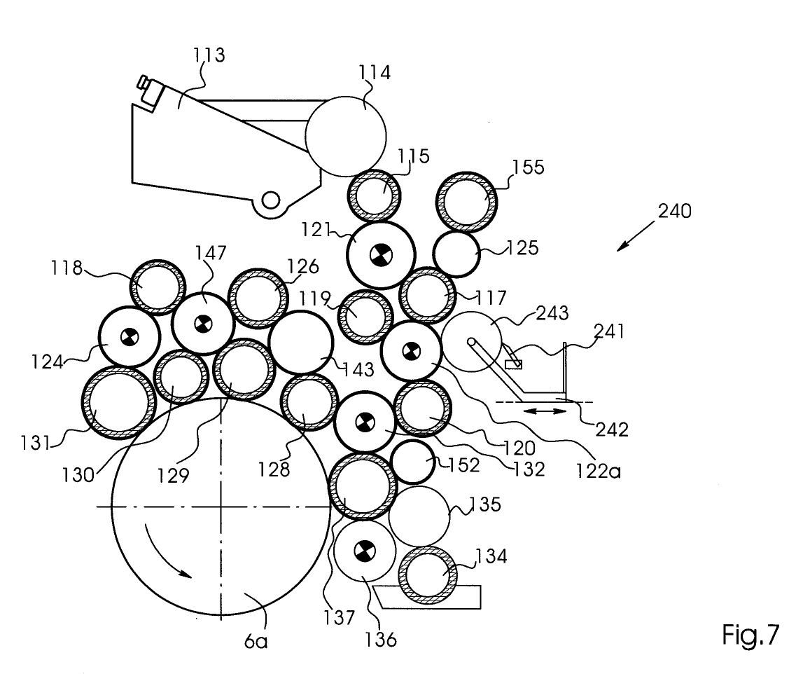

The exemplary embodiment shown in FIG. 7 corresponds to the one shown in FIG. 5, except for the following difference: In FIG. 7, the distributor roller 122a, like the remaining rollers of the inking unit, is provided with a phobic coating made of a fluoroelastomer or an organosilicon compound. The washing device 140 is formed of the washing blade 241, the collecting trough 242 and a roller 243, which is an integral part of the washing device 240. The roller 243, together with the blade 241 and the trough 242, is switched off during printing and is switched on for a washing operation, during which the roller 243 is in engagement with the phobic coated distributor roller 122a. The roller 243 includes a roller jacket made of copper, hard rubber, or Rilsan, which is ink-accepting and, due to its comparatively higher surface energy, accepts the ink residues removed from the rollers of the inking unit during a washing process so that the ink residues can then be stripped off through the use of the washing blade 241. An advantage of this exemplary embodiment is that all of the rollers in the inking unit have a “phobic” coating, and the non-“phobic” roller is only switched on during a washing operation. Of course, this embodiment may alternatively be constructed in such a way that the trough 242 and the blade 241 are fixed and only the roller 243, which bridges the gap between the distributor roller 122a and the washing blade 241, is switched on for a washing operation to close the gap. During a printing operation, the roller 243 can be pivoted away from the roller 122 and the blade 241 at an angle in a downward direction, for example.

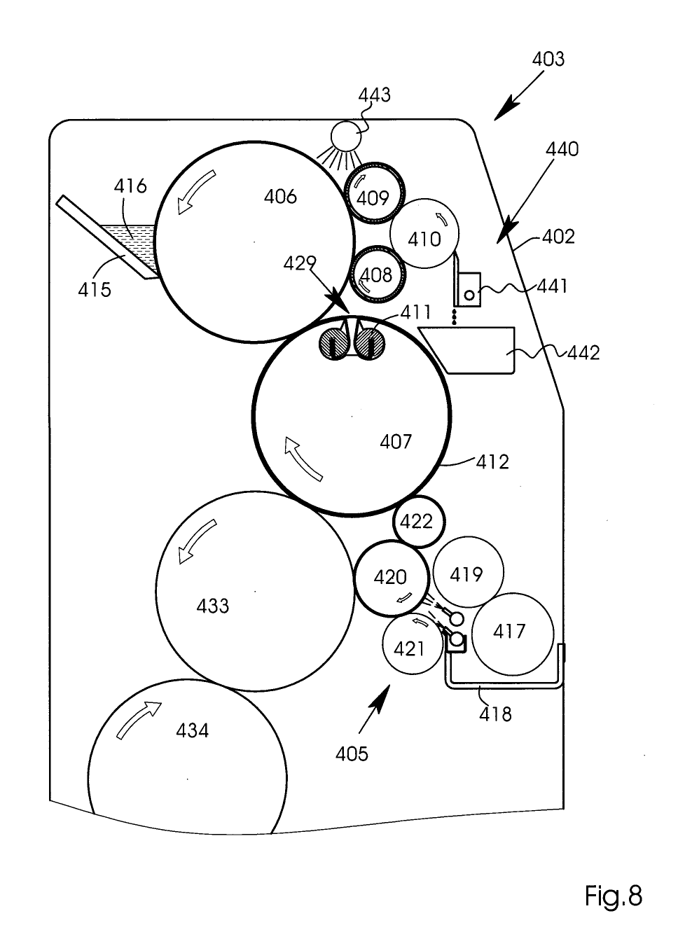

FIG. 8 illustrates an offset printing unit 402 including an anilox inking unit 403. The printing unit has a form cylinder or plate cylinder 433, a blanket cylinder 434 and a dampening unit 405 including a dampening solution pan roller 417, a metering roller 419, a dampening form roller or dampening solution applicator roller 420 and a dampening solution distributor roller 421. The anilox inking unit 403 includes a screen roller 406 and an ink applicator roller 407, both of which have the same diameter as the plate cylinder 433. In addition, the anilox inking unit 403 includes two rollers 408 and 409 that are in engagement with the screen roller 406 and a roller 410, which in turn rests against the two rollers 408 and 409 in a bridge-like manner. The ink applicator roller 407 has the same diameter as the screen roller 406 and the plate cylinder 433, yet it is provided with a mounting device 411 for mounting a blanket 412 that transfers ink from the screen roller 406 to the plate cylinder 433 or rather to the plate mounted thereon. Reference numeral 415 designates an ink blade resting against the screen roller 406 and receiving an ink supply 416. As is described in German Published, Non-Prosecuted Patent Application DE 101 03 585 A1, for example, the screen roller 406 is provided with a hydrophobic coating made of an organosilicon material or any other material with a relatively low surface energy. The same applies to the rollers 409 and 408 as well as 420 and 422 and for the blanket 412 mounted on the cylinder 407. In contrast, the roller 410 carries an otherwise uncoated Rilsan jacket. During a washing operation, the roller 410 is in engagement with a washing blade 441. When the ink supply 416 is empty or the ink blade 415 is pivoted away and the anilox inking unit is to be cleaned, a detergent is sprayed onto the screen roller 406 at a location 443. The dissolved ink residues will then collect on the surface of the non-coated roller 410, which has a Rilsan surface, for example, and can subsequently be effectively removed through the use of the washing blade 441.

In this case, too, the roller 410 may, of course, be coated to be phobic and an additional, uncoated roller may be associated with the cleaning device, for example. During a washing operation, this additional roller may, for example, be engaged in a gap between the roller 408 and the cylinder 407, where it collects ink residues that will subsequently be stripped off.

1. A printing press, comprising:
at least one printing unit having a printing plate;
at least one inking unit for inking said printing plate, said inking unit having inking rollers and a cleaning device associated with said inking rollers, said cleaning device having a blade device for removing ink from said inking unit;
said inking rollers including first rollers having a surface made of at least one material with a relatively lower surface energy and, at least during a cleaning operation, at least one second roller having a surface made of at least one material with a relatively higher surface energy than said at least one material of said surface of said first rollers; and
said blade device interacting with said at least one second roller.

2. The printing press according to claim 1, wherein said surface of said first rollers is coated with at least one of a fluoroelastomer or an organosilicon compound.

3. The printing press according to claim 1, wherein said material of said surface of at least one second roller is selected from the group consisting of Rilsan, hard rubber and copper.

4. The printing press according to claim 1, wherein said blade device can be brought into engagement with at least one second roller of said inking unit having a comparatively higher surface energy.

5. The printing press according to claim 1, wherein at least one second roller is part of said cleaning device and can be brought into engagement with one of said rollers of said inking unit for cleaning.

6. The printing press according to claim 4, wherein at least one second roller is a distributor roller.

7. The printing press according to claim 1, wherein second rollers in contact with said blade of said cleaning device during the cleaning operation are contacted by further second rollers having said relatively higher surface energy.

8. The printing press according to claim 1, wherein said second roller in contact with said blade of said cleaning device during the cleaning operation is contacted only by said first rollers having said relatively lower surface energy.

9. The printing press according to claim 6, wherein at least one of said rollers rests against said distributor roller and is a second roller, having said relatively higher surface energy.

10. The printing press according to claim 6, wherein several of said rollers rest against said distributor roller and are second rollers having said relatively higher surface energy.

11. The printing press according to claim 1, which further comprises a dampening unit associated with said inking unit and including rollers having a surface made of a material with a relatively higher surface energy.

12. The printing press according to claim 11, wherein said cleaning device is located on a side of said inking unit facing away from said dampening unit.

13. The printing press according to claim 11, wherein said cleaning device is located on a side of said inking unit facing toward said dampening unit.

14. The printing press according to claim 1, wherein said inking unit is a vibrator-type inking unit.

15. The printing press according to claim 14, wherein said vibrator-type inking unit has a vibrator roller with a rubber jacket formed of rubber having a relatively higher surface energy than coating materials of other rollers of said inking unit.

16. The printing press according to claim 1, wherein said inking unit is a short inking unit including a screen roller.

17. A method of removing ink from an inking unit of a printing press, the method comprising the following steps:
providing a plurality of first ink-guiding rollers or cylinders having a surface formed of materials with a relatively lower surface energy;
providing a plurality of second rollers having a surface formed of a material with a relatively higher surface energy;
assigning at least one of the second rollers to the inking unit, at least during an operation to remove ink from the inking unit; and
stripping the ink off at least one of the second rollers.

18. The method according to claim 17, wherein the second rollers are part of the inking unit, and a blade is brought into engagement with one of the second rollers.

19. The method according to claim 17, wherein at least one of the second rollers is part of a cleaning device and is brought, together with the cleaning device, into engagement with at least one roller of the inking unit.

20. The method according to claim 17, which further comprises cleaning an inking unit in a sheet-fed offset printing press.
